(19) United States
(12) Patent Application Publication
(10) Pub. No.: US 2007/0042077 A1
(43) Pub. Date: Feb. 22, 2007

(54) Deer attractant

(75) Inventors: Dale Morrell, Alma, AK (US); Wayne M. Hoelscher, Minnetonka, MN (US)

Correspondence Address: CARGILL, INCORPORATED, LAW/24, 15407 MCGINTY ROAD WEST, WAYZATA, MN, 55391, US

(73) Assignee: Cargill, Incorporated

(21) Appl. No.: 11/503,678

(22) Filed: Aug. 14, 2006

Related U.S. Application Data
(60) Provisional application No. 60/708,959, filed on Aug. 17, 2005.

(51) Int. Cl. A23K 1/18

(52) U.S. Cl. 426/2

(57) ABSTRACT

An animal feed suitable for attracting animals, such as deer, to a particular location is provided. The feed includes dried fruit and a fruit-flavored component. The fruit-flavored component can include artificially-flavored corn and/or a fruit-flavored, extruded feed component. Kits containing the animal feed and methods of using the animal feed are also provided.

### CROSS REFERENCE TO RELATED APPLICATIONS

This application claims priority of U.S. Provisional Patent Application Ser. No. 60/708,959 (filed Aug. 17, 2005), the complete disclosure of which is incorporated herein by reference.

### BACKGROUND

Another For many hunters, it is often desirable to lure animals to the hunter's location rather than to wait for the animals to randomly travel by. This is especially true in those situations where the animals are ruminants such as deer. Over the years, various products have been developed that can be used to lure deer to a hunter. Such products include: deer calls, deer-attracting scents, and deer-attracting feeds. Unfortunately, many of these products suffer from a number of drawbacks. For example, deer calls are often difficult to use and require a significant amount of practice to be skilled enough to call in the big bucks. The use of scents can be very hit or miss depending on the time of year, weather conditions, whether the animal is in the rut, etc.

Conventional feeds also suffer from a number of problems. For example, conventional feeds may not taste good enough to the deer to draw in large quantities and sizes of deer, especially bucks. Moreover, conventional feeds may not be sufficiently fragrant to attract deer. Conventional feeds may not be sufficiently aesthetically appealing to reliably and effectively attract deer.

Accordingly it would be desirable to provide a feed that can reliably and effectively attract animals, such as deer, especially big bucks, to the same location within a predictable time frame.

### SUMMARY

A feed is described herein which includes dried fruit (e.g., raisins, apples, etc.) and which may be used to reliably and effectively attract ruminants to the same location. The feed may be provided as a separate stand-alone feed (e.g., 5-gallon bucket of feed, etc.) or as a kit having suitable amounts of feed to attract the ruminants. A method is also described herein, which uses the feed to reliably attract ruminants.

Although the feed is described primarily in the context of attracting deer such as whitetail deer, mule deer, and the like, it should be appreciated that the feed may be suitable to attract a wide variety of wild ruminants, including, but not limited to: deer, elk, sheep, antelope, bison, caribou, and moose. The use of the feed to attract deer is particularly desirable since there are often restrictions on baiting other wild ruminants.

In one embodiment, the feed may include raisins and a fruit-flavored component. The fruit-flavored component may be any of a number of suitable natural and artificially flavored components. The use of the term “artificially flavored” herein shall mean any component to which a flavor is added during processing. It should also be understood that any of the components shown herein may be scented in the same manner that they are flavored (e.g., fruit scented, persimmon scented, artificially scented, etc.). In one embodiment, the fruit-flavored component may be an artificially-flavored natural grain, such as corn (kernels, mash, etc.) or an artificially-flavored extruded feed component. In another embodiment, the feed may include raisins and an extruded feed component that may optionally be artificially or naturally flavored.

In one embodiment, a kit may be provided that includes the deer feed described herein. The kit may include packaging such as a box, bucket, etc. which is used to hold the feed. For example, the kit may include packaging which is used to hold two or more separately packaged portions of the feed. The kit may also include instructions for using the feed. The instructions may be printed on the container, on the separately packaged portions of feed, or as a separate insert included with the packaged materials. In one embodiment, the instructions describe how to feed each separately packaged portion of feed on consecutive days. In another embodiment, each of the separately packaged portions of feed may contain different amounts of feed and different amounts (wt. %) of dried fruit in each portion.

The feed may be used to attract deer to the same location on subsequent days by repeatedly placing the feed at the location on subsequent days. In one embodiment, the feed is placed on the ground for consecutive days to repeatedly attract deer to the location. For example, the feed may be placed at a location on a first day, a second subsequent consecutive day, and, desirably, on a third subsequent consecutive day. The amount and composition of feed used for each day may be varied as desired. For example, the amount of feed used on the first day may be greater than the amount of feed used on the second day. Also, the amount of feed used on the second day may be greater than the amount of feed used on the third day. In addition, the wt. % of raisins or other dried fruit in the feed used on the first day may be greater than the wt. % of raisins or other dried fruit in the feed used on the second day, and so on. Of course, the amount of raisins or other dried fruit may also increase or remain constant in subsequent days feedings as well.

### DRAWINGS

FIG. 1 is a perspective view of a deer feeding kit according to one embodiment.

FIG. 2 is an exploded view of the kit shown in FIG. 1.

### DETAILED DESCRIPTION

Although the subject matter described herein is provided in the context of feeding deer, in particular whitetail and mule deer, it should be understood that the concepts and features described herein may be used in a variety of settings and situations as would be recognized by those of ordinary skill in the art. Also, it should be understood, that the features, advantages, characteristics, etc. of one embodiment may be applied to any other embodiment to form an additional embodiment unless noted otherwise.

The feed described herein includes dried fruit such as raisins and a fruit-flavored or scented feed component or morsel. The weight percentage of raisins in the feed may vary widely. For example, the feed may include about 1 to 30 wt. % raisins, desirably, about 2 to 15 wt. % raisins, or, suitably, about 3 to 10 wt. % raisins. The use of raisins in the feed may be desirable because it is believed that deer particularly like to eat them. It is believed that if raisins are present, deer will return to a site day after day to feed.

The composition of the fruit-flavored feed component may be varied in a number of ways. For example, in one embodiment, the fruit-flavored feed component may be an artificially-flavored grain. The artificially-flavored grain may be corn, wheat, oats, and/or any other suitable grain. The grain may be artificially flavored by coating the grain with any natural or synthetic flavor (e.g., natural apple flavoring or synthetic apple flavoring). The flavor coating may be persimmon. The artificially-flavored grain may provide both visual and oral appeal to deer. In another embodiment, the fruit-flavored feed component may be an extruded feed component. The feed component may be made of wheat midds, rice hulls, rice mill feed, high fat rice bran, low fat rice bran, soybean meal, oat hulls, corn germ meal, corn gluten feed, soy hulls, distiller grains, etc. The feed component may be artificially flavored with apple, raspberry, persimmon, grape, raisin, orange, banana, peppermint, anise, strawberry, etc., flavoring or scent. The fruit-flavored extruded feed component is desirable because it provides a low-cost, edible carrier for the strong fruit scent and flavor attractive to deer. In another embodiment, the fruit-flavored feed component may include dried fruit, such as apple, cranberry, banana, pears, dates, apricots, etc. In another embodiment, the fruit-flavored feed component may be brightly colored. The bright coloration may enhance the visual attractiveness of the feed to deer while also providing a pleasing visual appeal to the hunter.

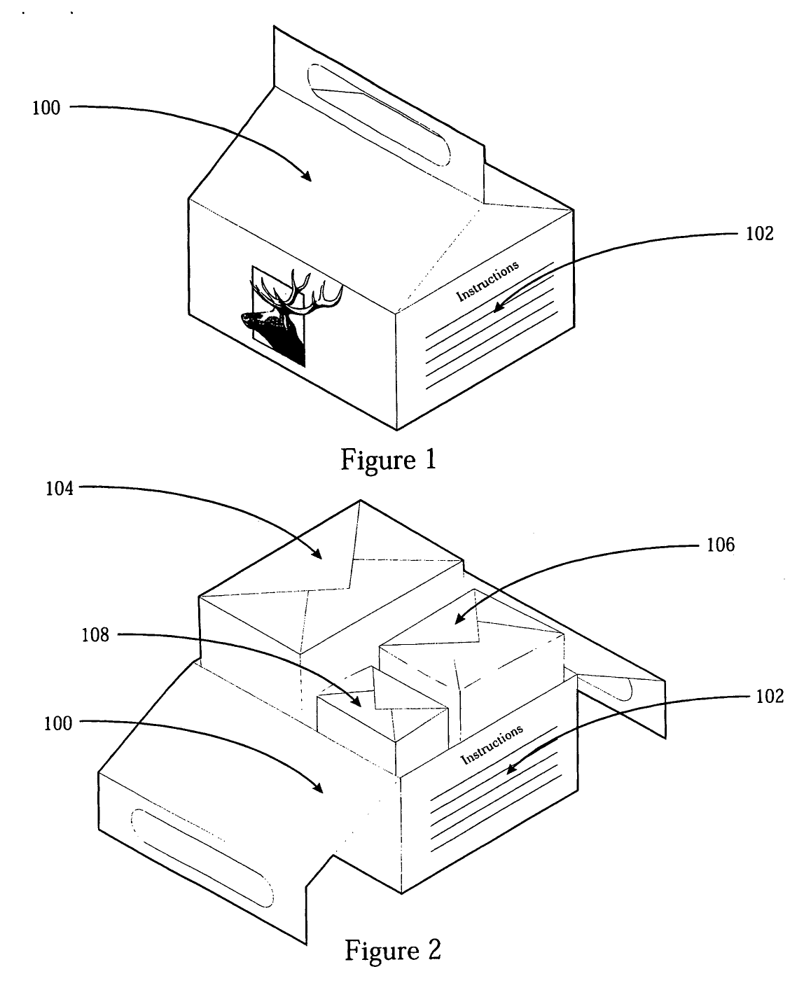

The feed may be included in a kit. As shown in FIG. 1, the feeding kit may include a container 100 for holding the feed. The container 100 may be a box, bag, jug, bucket, or other device, with or without a handle, suited for storing and carrying feed. The container 100 may be made of paper, cardboard, plastic, wood, metal, or other fit material. The container 100 may hold a unitary portion of feed to facilitate feed distribution a bit at a time at the discretion of the hunter or the kit may hold two or more separately-packaged portions of feed 106, 108, and 110 for use on consecutive days, as shown in FIG. 2. The kit may include instructions 102. The instructions 102 for use of the kit may be printed on a side of the container 100, as shown in FIG. 1-2, on the separately-packaged portions of feed 106, 108, and 110, or may be provided as a separate insert included with the kit. The instructions 102 may describe how to feed portions of feed derived from a unitary portion of feed or how to feed each separately-packaged portion of feed 106, 108, and 110 on consecutive days. The separately-packaged portions of feed 106, 108, and 110 may contain the same amount of feed or different amounts of feed. The separately-packaged portions of feed 106, 108, and 110 may contain the same amounts (wt. %) of dried fruit in each portion or different amounts (wt. %) of dried fruit in each portion.

While FIG. 2 illustrates a preferred way of packaging the feeding kit comprising three separately-packaged portions of feed 106, 108, and 110 enclosed in a carrying container 100 labeled with feeding instructions 102, any of a variety of packaging systems may be used according to other exemplary embodiments.

The feed may be used to attract deer to the same location on subsequent days by repeatedly placing the feed at that location on subsequent days. The feed may be placed on the ground on consecutive days to repeatedly attract deer to the location. For example, the feed may be placed at a location on a first day, at the same location on a subsequent consecutive second day, and at the same location on a subsequent consecutive third day. The amount of feed used may vary each day, as may the amount of dried fruit in the feed.

The method for feeding deer involves placing a portion of deer feed that includes raisins at a location on a first day, a portion of feed that includes raisins at the same location on a subsequent consecutive second day, and a portion of feed that includes raisins at the same location on a subsequent consecutive third day. In one embodiment, the portion of feed used on the first day is greater than the portion of feed used on the second day, and the portion of feed used on the second day is greater than the portion of feed used on the third day. In another embodiment, the wt. % of raisins used on the first day is greater than the wt. % of raisins used on the second day, and the wt. % of raisins used on the second day is greater than the wt. % of raisins used on the third day.

### EXAMPLES

The following examples are provided to further describe the subject matter disclosed herein. The following examples should not be considered as being limiting in any way.

In one embodiment, the feeding kit may include separately-packaged feed portions in a single container for use on each of three days as listed in Table 1. In this example, each feed portion is in a separate plastic bag. The bags are enclosed in a box having a handle.

TABLE 1

| Day | Amount of Feed |
|---|---|
| 1 | 9 lb plastic bag |
| 2 | 6 lb plastic bag |
| 3 | 5 lb plastic bag |

As shown in Table 1, the amount of feed is greatest on Day 1, the amount of feed is reduced on Day 2 and the amount of feed is further reduced on Day 3.

In this example, the feed is composed of a mixture of raspberry-flavored extruded ruminant morsels, apple-flavored extruded ruminant morsels, persimmon-flavored corn kernels, and raisins in the proportions listed in Table 2.

TABLE 2

| | Day 1 | Day 2 | Day 3 |
|---|---|---|---|
| Raspberry-flavored | 37% | 42% | 48% |
| extruded feed | | | |
| component | | | |
| Apple-flavored | 40% | 35% | 29% |
| extruded feed | | | |
| component | | | |
| Persimmon-flavored | 15% | 17% | 18% |
| corn kernels | | | |
| Raisins | 8% | 6% | 5% |

As shown in Table 2, the wt. % of raisins may be greatest on Day 1, the wt. % of raisins may be reduced on Day 2, and the wt. % of raisins may be further reduced on Day 3. The use of more raisins on Day 1 may be desirable to give the deer a good taste of the raisins. However, once the deer have acquired the taste for raisins, the amount may be reduced on subsequent days to lower the cost of the feed.

### ILLUSTRATIVE EMBODIMENTS

A number of illustrative embodiments of the subject matter described herein are provided below. The illustrative embodiments should be considered as providing only an exemplary number of examples, many of which may be expanded or modified in numerous ways to provide additional embodiments. Accordingly, the illustrative embodiments should not be considered limiting in any way.

The present application provides an animal feed, which may be used as an attractant for non-domesticated animals, such as deer. In one embodiment, the feed includes dried fruit, such as raisins, and a fruit-flavored feed component. In such embodiments, the fruit-flavored feed component may be an artificially-flavored feed component, i.e., a feed component which has been treated with a natural and/or artificial flavoring to impart a desired taste and smell. For example, the fruit-flavored feed component may be flavored with an apple, raspberry, and/or persimmon flavor.

In other embodiments, the animal feed may include two or more types of fruit-flavored feed components. Quite commonly, the fruit flavored feed component may be in the form of extruded feed ingredients. For example, the extruded material may suitably include wheat midds, rice hulls, and/or rice mill feed. In other embodiments, the extruded material may include wheat midds, rice hulls, rice mill feed, high fat rice bran, low fat rice bran, soybean meal, oat hulls, corn germ meal, corn gluten feed, soy hulls, and/or distiller grains. As shown in the examples discussed in the application, the fruit-flavored feed component may include an extruded material.

In addition to the fruit-flavored extruded material, the fruit-flavored feed component may include artificially-flavored corn. Quite commonly, the artificially-flavored corn may have a persimmon flavor, apple flavor, and/or raspberry flavor.

In one embodiment, the feed may be a deer feed which includes dried fruit, such as raisins, and an extruded feed component which typically is flavored with an artificial and/or natural flavoring. The extruded feed component may suitably include wheat midds, rice hulls, and/or rice mill feed. The extruded feed component may have a fruit flavor and be formed from one or more of the following ingredients: wheat midds, rice hulls, rice mill feed, high fat rice bran, low fat rice bran, soybean meal, oat hulls, corn germ meal, corn gluten feed, soy hulls, and/or distiller grains. Commonly, the extruded feed component may have an apple and/or raspberry flavor.

In another exemplary embodiment, the extruded feed component may be brightly colored.

In some embodiments, the feed (e.g., a deer feed) may include about up to about 30 wt. % of a dried fruit, such as raisins. Quite commonly, the feed may include raisins and artificially-flavored corn. The artificially-flavored corn may suitably have a fruit flavor. For example, the artificially-flavored corn may have a persimmon flavor, apple flavor, and/or raspberry flavor. In such embodiments, the artificially-flavored corn may suitably be a first flavored feed component, and the deer feed may include a second flavored feed component having a fruit flavor, e.g., a raspberry-flavored and/or apple-flavored extruded feed component.

In yet another exemplary embodiment, the deer feed may include about 0.5 to 30 wt. % raisins. In such an embodiment, the deer feed may include artificially-flavored corn. Commonly, the artificially-flavored corn has a persimmon flavor, apple flavor, and/or raspberry flavor. In such embodiments, the deer feed may desirably include about 2 to 15 wt. % raisins, or suitably, about 3 to 10 wt. % raisins.

One embodiment provides a kit for feeding and/or attracting deer including a plurality of feed portions each of which includes raisins, the plurality of feed portions being separate from each other, wherein the plurality of feed portions each typically include raisins in differing amounts. In another exemplary embodiment, each of the plurality of feed portions in the kit includes an extruded feed component. In such embodiments, at least one of the plurality of feed portions may include about 1 to 30 wt. % raisins, desirably, about 2 to 15 wt. % raisins, or suitably, about 3 to 10 wt. % raisins. In an exemplary embodiment, at least one of the plurality of feed portions in the kit may commonly include an apple flavored feed component, a raspberry flavored feed component, and/or a persimmon flavored feed component. In another exemplary embodiment, at least one of the plurality of feed portions in the kit may include artificially-flavored corn and a fruit-flavored, extruded feed component, e.g., an extruded feed material having an apple or raspberry flavor.

In yet another exemplary embodiment, the kit may include at least three feed portions. In such embodiments, one or more of the plurality of feed portions may commonly include a plurality of brightly colored feed morsels of differing colors. One or more of the feed portions may include a plurality of fruit-flavored feed components. In an exemplary embodiment, at least one of the plurality of feed portions in the kit may include artificially-flavored corn. Suitably, the artificially-flavored corn may have a persimmon flavor, apple flavor, and/or raspberry flavor.

Another embodiment provides a kit for feeding deer including a plurality of feed portions separated from each other, each of which includes raisins, wherein the plurality of feed portions include differing amounts of deer feed. Suitably, at least about 50 wt. % of the deer feed in each of the plurality of feed portions is an edible carrier which provides little nutritional value.

Yet another embodiment provides a kit for feeding deer including a plurality of separately packaged feed portions each of which includes raisins, and instructions for feeding the separately packaged feed portions to deer at a location on consecutive days to repeatedly attract the deer to the location. In other embodiments, the kit may include a box which is used to hold the separately packaged feed portions. Suitably, the instructions may be provided on the box. One embodiment provides a kit for feeding deer including a plurality of feed portions each of which includes raisins; the plurality of feed portions being separate from each other; and packaging which is used to group the plurality of feed portions together to form the kit.

Another embodiment provides a method for feeding and/or attracting animals, such as deer. The method includes including placing feed which includes dried fruit, such as raisins, at a location on a first day and on one or more subsequent days to attract animals to the location.

In some embodiments, the method provides that the amount of deer feed placed at the location on the first day is greater than the amount of deer feed placed at the location on the second day. In such embodiments, the method may include placing deer feed which includes raisins at the location on a third day which is subsequent to the second day, wherein the amount of deer feed placed at the location on the third day is less than the amount of deer feed placed at the location on either the first day or the second day.

In another exemplary embodiment, the method provides that the concentration of raisins in the deer feed placed at the location on the first day is greater than the concentration of raisins in the deer feed placed at the location on the second day.

One embodiment provides a method for feeding deer including placing a first deer feed portion which includes dried fruit at a location on a first day, and commonly placing a second deer feed portion which includes dried fruit at the location on a second day which is after the first day. One embodiment provides a deer feed including raisins and another fruit flavored feed component. In another embodiment, the method provides that the first deer feed portion is greater than the second deer feed portion. In yet another embodiment, the method provides that the concentration of raisins in the first deer portion is greater than the concentration of raisins in the second deer feed portion. In some embodiments, the method provides placing a third deer feed portion which includes raisins at the location on a third day which is after the second day, wherein the third deer feed portion is smaller than the first deer feed portion and the second deer feed portion. The deer feed portions may include artificially flavored corn.

One embodiment includes placing an animal feed comprising dried fruit; artificially-flavored corn; and a fruit flavored, extruded feed component. In some embodiments, the animal feed may include about 0.5 to 30 wt. % raisins, desirably, about 2 to 15 wt. % raisins, or suitably, about 3 to 10 wt. % raisins.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., common use and/or technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Accordingly, the claims are not tied and should not be interpreted to be tied to any particular embodiment, feature, or combination of features other than those explicitly recited in the claims, even if only a single embodiment of the particular feature or combination of features is illustrated and described herein. Thus, the appended claims should be read to be given their broadest interpretation in view of the prior art and the ordinary meaning of the claim terms.

As used herein, spatial or directional terms, such as “left,” “right,” “front,” “back,” and the like, relate to the subject matter as it is shown in the drawing Figures. However, it is to be understood that the subject matter described herein may assume various alternative orientations and, accordingly, such terms are not to be considered as limiting. Furthermore, as used herein (i.e., in the claims and the specification), articles such as “the,” “a,” and “an” can connote the singular or plural. Also, as used herein, the word “or” when used without a preceding “either” (or other similar language indicating that “or” is unequivocally meant to be exclusive—e.g., only one of x or y, etc.) shall be interpreted to be inclusive (e.g., “x or y” means one or both x or y). Likewise, as used herein, the term “and/or” shall also be interpreted to be inclusive (e.g., “x and/or y” means one or both x or y). In situations where “and/or” or “or” are used as a conjunction for a group of three or more items, the group should be interpreted to include one item alone, all of the items together, or any combination or number of the items. Moreover, terms used in the specification and claims such as have, having, include, and including should be construed to be synonymous with the terms comprise and comprising.

Unless otherwise indicated, all numbers or expressions, such as those expressing dimensions, physical characteristics, etc. used in the specification are understood as modified in all instances by the term “about.” At the very least, and not as an attempt to limit the application of the doctrine of equivalents to the claims, each numerical parameter recited in the specification or claims which is modified by the term “about” should at least be construed in light of the number of recited significant digits and by applying ordinary rounding techniques. Moreover, all ranges disclosed herein are to be understood to encompass any and all subranges subsumed therein. For example, a stated range of 1 to 10 should be considered to include any and all subranges between and inclusive of the minimum value of 1 and the maximum value of 10; that is, all subranges beginning with a minimum value of 1 or more and ending with a maximum value of 10 or less (e.g., 5.5 to 10).

What is claimed is:

1. An animal feed comprising:
dried fruit; artificially-flavored corn; and a fruit-flavored, extruded feed component.

2. The animal feed of claim 1, wherein the dried fruit comprises raisins.

3. The animal feed of claim 1, wherein the artificially-flavored corn has a persimmon flavor, apple flavor, and/or raspberry flavor.

4. The animal feed of claim 1, wherein the artificially-flavored corn is flavored with a natural flavoring.

5. The animal feed of claim 1, wherein the artificially-flavored corn is flavored with a synthetic flavoring.

6. The animal feed of claim 1, wherein the fruit-flavored, extruded feed component comprises wheat midds, rice hulls, and/or rice mill feed.

7. The animal feed of claim 1, wherein the fruit-flavored, extruded feed component is flavored with a natural flavoring.

8. The animal feed of claim 1, wherein the fruit-flavored, extruded feed component is flavored with apple flavoring, raspberry flavoring, persimmon flavoring, grape flavoring, raisin flavoring, orange flavoring, banana flavoring, peppermint flavoring, anise flavoring, and/or strawberry flavoring.

9. The animal feed of claim 1, wherein the fruit-flavored, extruded feed component comprises wheat midds, rice hulls, rice mill feed, high fat rice bran, low fat rice bran, soybean meal, oat hulls, corn germ meal, corn gluten feed, soy hulls, and/or distiller grains.

10. The animal feed of claim 1, wherein the dried fruit comprises raisins;
the artificially-flavored corn comprises persimmon flavored corn; and
the fruit-flavored, extruded feed component comprises a raspberry flavored, extruded feed component.

11. The animal feed of claim 10, wherein the fruit-flavored feed component further comprises an apple flavored, extruded feed component.

12. The animal feed of claim 1, wherein the dried fruit comprises raisins;
the artificially-flavored corn comprises persimmon flavored corn; and
the fruit-flavored feed component comprises an apple flavored, extruded feed component.

13. A kit for attracting deer comprising:
a plurality of feed portions which are separate from each other, wherein each of the feed portions comprises dried fruit; artificially-flavored corn; and a fruit-flavored, extruded feed component; and
each of the feed portions includes a different dried fruit weight percentage.

14. The kit of claim 13, comprising at least three feed portions.

15. The kit of claim 13, further comprising instructions for use of the kit;
wherein the instructions instruct a user to distribute a first feed portion at a location on a first day; and
to distribute a second feed portion at the location on a subsequent day; the second feed portion having a lower dried fruit content than the first feed portion.

16. The kit of claim 13, wherein the dried fruit comprises raisins;
the artificially-flavored corn comprises persimmon-flavored corn; and
the fruit-flavored, extruded feed component comprises a raspberry flavored, extruded feed component and/or an apple flavored, extruded feed component.

17. A method for attracting deer comprising:
placing a first deer feed portion at a location on a first day; wherein the first deer feed portion includes dried fruit; artificially-flavored corn; and a fruit-flavored, extruded feed component; and
placing a second deer feed portion at the location on a subsequent day; wherein the second deer feed portion includes the dried fruit; the artificially-flavored corn; and the fruit-flavored feed component.

18. The method of claim 17, wherein the first deer feed portion is larger than the second deer feed portion.

19. The method of claim 17, wherein the second feed portion has a lower dried fruit content than the first feed portion.

20. The method of claim 17, further comprising placing a third deer feed portion at the location on a third day which is after the subsequent day, wherein the third deer feed portion includes the dried fruit; the artificially-flavored corn; and the fruit-flavored, extruded feed component.
